(19) United States
(12) Patent Application Publication
(10) Pub. No.: US 2005/0131785 A1
(43) Pub. Date: Jun. 16, 2005

(54) Method and apparatus for management, financing and supply in an integrated supply chain system

(76) Inventor: Chin Kok Yap, Singapore (SG)

Correspondence Address: SUGHRUE MION, PLLC, 2100 PENNSYLVANIA AVENUE, N.W., SUITE 800, WASHINGTON, DC, 20037, US

(21) Appl. No.: 10/497,107

(22) PCT Filed: Nov. 28, 2002
(86) PCT No.: PCT/SG02/00278

(30) Foreign Application Priority Data
Nov. 28, 2001 (AU) 2001100598

(51) Int. Cl. G06F 17/60

(52) U.S. Cl. 705/35; 705/37

(57) ABSTRACT

A method and apparatus for providing trade financing to inventory suppliers (210), manufacturers (230), or both, on the basis of a zero inventory model. The method and apparatus involves the generation of a security on the basis of inventory ownership combined with either or both of a purchase guarantee from an inventory purchaser and an assignment of accounts receivable by an inventory supplier (210). The invention also involves an integrated supply chain process (S1-S4-S11-S13) and event notification interface (30) that can perform financial transactions and electronic proof of delivery in support of such zero inventory model financing.

### FIELD OF THE INVENTION

The present invention relates to a method and apparatus for providing trade financing to inventory suppliers, manufacturers, or both, within an integrated supply chain system. The present invention further relates to a process and event notification interface that can perform financial transactions and electronic proof of delivery.

### BACKGROUND OF THE INVENTION

The introduction of supply chain management (SCM) has revolutionized the ability of businesses to control and regulate the flow of inventory and to smooth the flow of inventory from inventory suppliers to manufacturers. Optimization of financial performance is possible since SCM can reduce inventory stock levels to the minimum that is then required for the manufacturer. In achieving such optimization, valuable capital can be freed up for the operation of the business, instead of being tied up to buffer excessive inventory levels. Integration into SCM of various operational and physical aspects of a business is a key to achieving the best managed flow of inventory, while at the same time minimizing the financial impact of holding inventory for the business.

However, one of the key problems encountered in SCM is the multi-tier process of successive ownership transfer from one inventory supplier to another, whether or not additional value is added. Even though the inventory eventually ends up with the manufacturer, it is accompanied by a rather high mark-up on top of the original value of the inventory plus value added, due to such a multi-tier ownership process.

Despite such increased costs, manufactures do not wish to hold inventory for an excessive time period, since it will reduce the amount of free capital available to them, increase their direct storage and warehousing costs, and generally restrict the manufacturer's ability to optimise inventory management.

Currently, there are two prevailing financing models used in SCM and the logistics industry in general, Supplier Owned Inventory (SOI) and Manufacturer Owned Inventory (MOI), with several variations also existing, such as VMI (Vendor Managed Inventory). These (VMI, SOI) are solutions made to ensure that manufacturers do not hold inventory until they require such inventory for actual manufacturing.

While these models solve problems of manufacturers, they create problems for the inventory suppliers, who become laden with the obligation of holding such inventor in their accounting books. As a result, the inventory supplier must now find trade financing from a financial institution. However, the inventory supplier faces significant limitations in obtaining favorable terms for such financing, both as to rate and loan amount.

Typically, a supplier of goods will strive to operate on a cash-on-delivery or cash-on-purchase order basis in an ideal environment. However, notwithstanding the advantages of modem commercial practices, such as are provided by B2B and B2C systems and techniques, two basic financing approaches still are used, “accounts receivable financing” and “inventory financing.”

In current “accounts receivable financing” (AR financing) practices, for example, a supplier may sell $1,000,000 worth of computer hard-drives to a manufacturer of computer systems, and provide a credit term of 60 days to the manufacturer. The manufacturer, being a $20 billion conglomerate, with credit ratings that may exceed those of third world countries, can provide the supplier recourse. The supplier then offers its sale receipts or invoices to a financier for immediate payment of the sale value, less a discount that the financier will charge the supplier. The rate of discount depends on the credit rating of the manufacturer. At the end of the 60 days, the financier will receive the full payment ($1,000,000) from the manufacturer. The above method uses financial instruments such as commercial notes.

The alternative “inventory financing” method involves the supplier pledging the ownership or title of goods of a certain value to the financier, in return for operating cash. This may be favorable in the case where the supplier may be selling goods that have a very short turnover time (time of inventory to time of sale to customer). For example, an oil trader may have on hand $1,000,000 worth of crude oil that is typically sold within a 7-day period to a variety of customers. The oil trader may need money for the transport of the oil to the various customers in a multitude of destination countries. In effect, the oil trader will “mortgage” the oil inventory to the t financier for cash. The rate and schedule of charges that the financier will impose on the supplier depends on the quality of the pledged inventory. Oil is a commodity with a generally short-term price stability, and a long-term market. On the other hand, semiconductor chips have neither price stability nor long term market value. Thus, a financier would not release $1,000,000 to a supplier of DRAM chips for a 60-day period, when the prices of DRAM chips may be 30% down in a period of 10 days,

It also is quite rare, if not impossible, for a bank to accept inventory that the customer does not own (because it has sold than in exchange for accounts receivables) as collateral for a loan. Thus, where there is a need for financing for $1 million worth of inventory, but half is already sold, and the other half is allocated for sale due to a third party arrangement with the customer, such as a conditional purchase forecast (common in the industry), inventory financing is limited. A bank will simply finance $500,000 at best. In the case where half is allocated for sale, but there is no existing sale invoice from the customer, since the customer only has a conditional forecast that the other half of the inventory may be sold to one or more manufacturers within a period, the bank would not finance the remaining $500,000 of inventory. In short, the inventory supplier can not make use of inventory sold to customers as collateral to obtain a lower cost of financing.

There are further differences between the case where a customer simply pledges accounts receivables and the case where there is inventory financing.

For example, the bank may offer different rates based on different collateral being pledged by the customer (inventory may be financed at 8% pa, up to 50% of the value of inventory, while accounts receivables maybe financed at 6% pa, up to 80% of the value of account receivables)

Thus, there is a clear need to find a way to optimize the use of inventory ownership and/or control so that the most favorable financing terms can be achieved, yet quick payment to supplies and just in time delivery to manufacturers can be attained as well. The present invention satisfies such need, including but not limited to offering the inventory supplier a single low rate of financing.

The financing requirements of the manufacturer and inventory supplier are further amplified by the way certain physical processes in the logistics chain are separated from current electronic SCM systems, particularly certain financial processes that are crucial in the entire SCM process. One such financial process is inventory financing.

Existing SCM electronic systems are built and operated with emphasis on operations and processes directly related to supply chain management. However, there is no “real” or direct integration of financial processes commonly required by the inventory supplier, manufacturer, or both, such as inventory financing etc. Currently, “integrated” supply chain systems are ones that are capable of merging supply chain data and generating invoices, purchase orders, or electronic documents related to shipping and handling etc. The problem arising from such “integrated systems” is the lack of true physical integration of certain process into the supply chain, such as the delivery of inventory from the supply chain intermediary to the inventory purchaser, typically the manufacturer. When the inventory is physically delivered, and possession, ownership and/or control handled over to the inventory purchaser, the purchaser will typically sign on an invoice receipt commonly deemed as a “proof-of-delivery”. The invoice receipt will then be routed back to a human operator naming the supply chain system, who will manually update related information in the system database, and thus start the financial process (i.e., payment) related to such a delivery. Clearly, this adds cost to the overall process and is generally not efficient. Moreover, there maybe inaccuracies and delays in recording and communicating the related events or activities, since the physical activities (such as the delivery and handing over of inventory) are not electronically connected to the supply chain management system.

Clearly, there is a need for the supply chain processes to be capable of sending system information on the status of each process and/or event, and to be able to automatically trigger other related activities and SCM processes. The goal is to dramatically improve the overall efficiency of the supply chain management system and provide the supply chain intermediary with the ability to perform and complete services accurately and in the least amount of time.

### SUMMARY OF THE INVENTION

The present invention concerns a zero inventory model for financing the production, sale, storage and delivery of goods in a supply chain having just in time capability. The invention further concerns a supply chain system for implementing such zero inventory model, including rapid and efficient event notification and the provision of electronic proof-of-delivery.

In traditional financing, the inventory supplier can raise money from the pledging of sale receipts to the financier. In zero inventory model (ZIM™) financing, the supply chain intermediary secures title and/or control of inventory and combines such asset with purchase guarantees and/or assigned accounts receivable to securitize the financing.

In one exemplary embodiment of the present invention, the supply chain intermediary owns the inventory and secures the purchase guarantee from the subsequent purchaser of the inventory. In another exemplary embodiment, the supply chain intermediary also owns the inventory but secures an assignment of accounts receivable from the supplier. In both embodiments, the supply chain intermediary is in possession of two different assets, and uses that combination to create a negotiable bankable instrument that can be used for asset securitization and subsequently funding This method creates a very safe security for the supply chain intermediary to obtain a very low cost of financing. The inventory supplier does not need to present sale receipts or collateral to the supply chain intermediary to get a shorter payment cycle. This is because the supply chain intermediary has taken the role of securing the purchase guarantee from the manufacturer, while at the same time holding ownership to the inventory that is tied to such a guarantee. Alternatively, the supply chain intermediary has combined an assignment of account receivables from the supplier, while at the same time holding ownership and control of the inventory that is tied to the account receivable.

The only party that is physically and financially-positioned to offer such safe security is the supply chain intermediary, since inventory is physically delivered in succession from the supplier to the manufacturer. Zero inventory model (ZIM™) financing, in one exemplary embodiment, is a method whereby the supply chain intermediary secures a purchase guarantee from the manufacturer or assignment of accounts receivable from the supplier, and ownership of inventory from the supplier, attaches the two instruments into a single security for a financier to provide a very low cost of financing to the supplier, manufacturer or both This satisfies the requirements of two parties involved in the supply chain. First, the supplier gets a shorter payment cycle at a lower rate. Second, an inventory purchaser (e.g., a manufacturer) can receive the benefit of just-in-time access to inventory.

Each financial process (to make payment available for the inventory) may be any kind of arrangement that the intermediary may implement with any other third party such as a financial service provider. Significantly, the two financing methods do not involve a brokering model, since the supply chain intermediary takes physical ownership and/or control of the inventory prior to the provision of the inventory to the manufacturers.

The possession and control of the inventory by the supply chain intermediary permits the intermediary at the request of the inventory supplier, the manufacturer, or both, to perform additional value-adding actions or steps to the physical inventory. For example, the manufacturer may require a supplier of computer display devices to label such devices with a sticker label of the manufacturer, before the manufacturer purchases the devices from the supplier. Because the supplier is usually an OEM (original equipment manufacturer) of the device, under conventional arrangements, labeling of such devices may require yet another third party to perform the additional steps (plus contracting, delivering and receiving activity). Very often, such a device is labeled and then handled over to the supply chain intermediary for storage management. The supply chain intermediary can easily provide the additional labeling service for the supplier, since the inventory (of such devices) will ultimately be handed over to the intermediary anyway.

The inventory supplier will also face the issue of getting paid for the devices supplied to the manufacturer after a stipulated time (credit period). The supply chain intermediary, should it perform similar services to a multitude of suppliers, can consolidate the financing requirement of the collective group of suppliers and provide a shorter payment cycle. At the same time, the intermediary can implement additional value added services, including manufacturing or assembly processes for the suppliers.

This two-into-one service provision to the suppliers can dramatically improve the entire supply chain process, as the amount of physical transfer and ownership transfer is reduced. For example, there is no need to ship the devices from supplier to a labeling company, and then to the supply chain intermediary. The vital role that the supply chain intermediary plays with respect to the manufacturer, inventory supplier or both is its ability to undertake processes to physically enhance or prepare the inventory for subsequent processes along such a supply chain.

Since the supply chain process contemplates that the supply chain intermediary will take ownership and/or control of the inventory, the supply chain intermediary will have the ability to make use of its own internal financing sources to raise finds to implement the actions or steps required to perform this “value-added” service. Financing to the inventory suppliers, the manufacturers, or both, becomes a favorable process that can reduce the cost of financing for the inventory supplier, the manufacturer, or both. This is because the supply chain intermediary is able to make use of the collective store of inventory from a plurality of inventory suppliers to secure a much lower cost of funds than that available through the individual financing efforts of each inventory supplier.

This supply chain arrangement is desirable for the supply chain intermediary as well, since its ownership and/or control of the inventory allows the intermediary to also easily perform additional “value-added” services that the manufacturers demand from the inventory suppliers.

The foregoing financing methods take advantage of the requirement of the manufacturers, and/or inventory suppliers to provide another useful service to both entities.

In another preferred embodiment, the supply chain intermediary may also undertake to perform the additional steps while a third party implements financing to the inventory supplier, manufacturer, or both, similar to methods described in the first exemplary embodiment.

The present invention can also electronically broadcast messages, data and/or information relating to a particular or a series of supply chain processes or events, to a plurality of mobile devices such as a mobile phone, mobile computer etc. The system can require that several conditions or parameters must be met prior to the electronic broadcasting of the messages. For example, the system can monitor the quantity of current inventory, and once such inventory meets certain pre-stored conditions, trigger the system to broadcast a message to a predetermined device. The invention can also allow for different type of devices to be notified of the message, depending on the conditions set on the system. Preferably, the invention can send a simple email message, if the condition set by the system is not an urgent (or time sensitive) notification. Preferably, the invention can send the message to a mobile phone if the inventory under monitoring falls within a condition that warrants immediate attention. Thus, the invention provides a unique system whereby conditions of each supply chain process can be programmed into the system, and the conditions can provide the users of the system the ability to determine the urgency of each condition, and to broadcast the message to a specific device, including but not limited to mobile phones, mobile computers, personal digital assistants etc.

The present invention can also allow the supply chain intermediary to electronically initiate a mobile device (that had pre-registered with the supply chain system of the supply chain intermediary) owned by the manufacturer, to input a password or PIN and electronically validate a transaction, approve the delivery of inventory at hand, and at the same time, via the mobile device, instruct payment instructions to be made from the manufacturer to the pre-determined bank account of the supply chain intermediary. This electronic method to validate a “proof-of-delivery” (ePOD) between the supply chain intermediary and the manufacturer, and also integrates the financial processes (in this case the direct payment instructions from the inventory purchaser to the supply chain intermediary) alongside the supply chain process. A dramatic increase in efficiency and speed in such a transaction is achieved since two processes are simultaneously performed at the time when such a process is taking place, or has already been finished (such as the delivery and handing over of inventory to the manufacturer). In addition, this electronic ePOD can also initiate the transfer of ownership of the inventory from the supply chain intermediary to the manufacturer. Mobile devices or dedicated computer units are also attached to the various components of a supply chain electronic system operated by the supply chain intermediary.

### BRIEF DESCRIPTION OF THE DRAWINGS

In order that the invention may be more clearly ascertained, preferred embodiments will now be described, by way of example, with reference to the accompanying drawings, in which:

FIG. 1A is a flow chart illustrating the basic steps for zero inventory method financing where securitization of financing is based on goods in inventory and acquired purchase guarantees from a manufacturer;

FIG. 1B is a flow chart illustrating the basic steps for zero inventory method financing where securitization of financing is based on goods in inventory and an assignment of accounts receivable from a supplier;

FIG. 2A is a schematic view of a portion of the transactions in a system implementing zero inventory method financing, where a supply chain intermediary takes ownership of inventory from one or more inventory suppliers and provides the inventory suppliers with a cash payment or advance based upon specific supply chain processes;

FIG. 2B is a schematic view of a portion of the transactions in a system implementing zero inventory method financing, where a manufacturer requests from the supply chain intermediary ownership of inventory either in incremental quantities or its entire quantity, with the manufacturer effecting payment, for example, on the ePOD communications unit, and providing a purchase guarantee;

FIG. 2C is a schematic view of a portion of the transactions in a system implementing zero inventory method financing, where a supply chain intermediary takes ownership of inventory from one or more inventory suppliers as well as an assignment of accounts receivable, and provides the inventory suppliers with a cash payment or advance based upon specific supply chain processes;

FIG. 3A is a schematic view of a system arrangement for zero inventory method financing, which supports the electronic broadcast and alert of a pre-determined plurality of mobile devices when certain supply chain processes and/or events trigger the system, according to an exemplary embodiment of the present invention; and

FIG. 3B is a schematic view of a portion of the system arrangement for zero inventory method financing, which illustrates a mobile device sending electronic data and authentication data input from the user to the mobile communications unit, and upon successful user authentication, routing of electronic data to a financial interface module for implementation of financial processes with a financial institution.

### DETAILED DESCRIPTION OF THE PREFERRED EMBODIMENTS

In order that the invention may be more clearly ascertained, exemplary and preferred embodiment are subsequently described that by way of example and with reference to the accompanying drawings, provide an enabling description of the invention. These exemplary embodiments are not intended to be limiting, but to provide some examples of the manner in which the invention may be made and used One skilled in the art would be enabled to make and use the invention according to other embodiments based upon these teachings, and such additional embodiments are within the scope of the present invention.

In a typical scenario for implementing zero inventory (ZIM™) financing, at least three of the following four parties would be involved:

a supply chain intermediary;

an inventory supplier;

a manufacturer; and

a financier.

Typically, the “supply chain intermediary,” or “service provider” is the operator of the technology behind ZIM™ financing, and may comprise one or more parties. At a minimum, the intermediary would (1) supply the actual operational services involved in ZIM™ financing and (2) operate and implement the contractual and data processing aspects of ZIM™ financing. Preferably, these two functions would be performed by separate, although related, entities.

The “financier” will be the entity that evaluates the credit ranking and financial considerations of a typical ZIM™ transaction, and makes use of securities that may be provided by the supply chain intermediary to procure financing for the intermediary.

The “inventory supplier” is the ZIM™ service consumer who provides the inventory and has an immediate requirement for a shorter payment cycle, comparatively lower transaction cost and lower interest rate, as compared to those available from conventional financing products, such as account receivable financing and inventory financing.

The “manufacturer” or other “inventory purchaser” is a ZIM™ service consumer who desires to purchase inventory, but has an immediate requirement for deferred delivery and ownership of inventory, usually on a just-in-time basis, from the supplier.

In either AR financing or inventory financing, there is usually a base cost attached to the risk that is being perceived by the financier. The riskier the deal, the higher the charges, or in many cases, the financier will not even consider funding the supplier.

However, if the supplier can finance the sale (for $1,000,000 worth of hard-drives) via a sale invoice and collateral of the inventory (the hard-drives), the risk level is significantly decreased, and so is the cost of financing. This scenario is akin to the supplier selling the hard-drives to the manufacturer, selling the invoices to get financing and asking the manufacturer to pledge the inventory to the financier. In this example the manufacturer is a computer notebook maker, with a multitude of suppliers for the various components required for the manufacture and assembly of the notebook. It will be understood, however, that the manufacturer could be a producer of essentially any goods.

A single supplier of such components, who will be referred to as the “inventory supplier,” will be described, however, it will also be understood that a manufacturer could obtain components from a plurality of such suppliers. The supplier supplies computer hard-drives to the manufacturer, using the supply chain intermediary as the supply chain manager. The manufacturer currently only wishes to hold inventory (of the hard-drives) that is adequate for the actual current manufacturing requirements. The supplier, however, will only sell the inventor in a specific wholesale quantity. As a result, the supplier will usually own the entire value of the inventory until the manufacturer actually purchases the inventory.

The supplier complies with the manufacturer's wish by finding a source for financing. Conventionally, the supplier will pledge the inventory as collateral to the intermediary (inventory financing), or obtain financing from the sale receipts of the inventory from the manufacturer (accounts receivable financing).

In the case of inventory financing, inventory that is pledged to the intermediary will be discounted by the intermediary by a certain percentage, for example, computer hard-drives may be discounted by 15% for a financing period of 60 days. The supplier may have $1,000,000 worth of bard-drives in actual inventory—and therefore will perhaps obtain only US$850,000 in financing. This is due to the existence of a possibility of obsolescence of the inventory. The intermediary may also charge the supplier an interest rate of about 7% per annum.

In the financing method of pledging sale receipts (accounts receivable financing), the financier will evaluate the credit worthiness of the supplier's customer—which in this case, is the manufacturer of the notebooks. The financier may finance the supplier in the variety of ways—usually the required amount that the supplier has requested for ($1,000,000), plus an interest rate. The interest rate in this case may vary, depending on the risk assessment by the financier of the manufacturer. The problem may arise when the supplier has very tight profit margins of the computer hard-drives (inventory). This may make the cost of financing relatively expensive to the supplier.

The supplier cannot combine the two forms of financing because the supplier cannot obtain inventory financing if the inventory is sold to the manufacturer.

A low cost of financing can be obtained in the case where the sold inventory is collateral, and either a purchase guarantee is obtained from the manufacturer (inventory purchaser) or the sale receipts are pledged to the financial intermediary. The former is akin to the supplier selling the hard-drives to the manufacturer, pledging the sale receipts to the intermediary, and asking the manufacturer to pledge the sold inventory to the intermediary. The inventory supplier cannot implement such financing technique,—but the supply chain intermediary can, easily do so.

In the case of the supply chain intermediary, the inventory is physically residing within the intermediary's storage facilities for a time period, before being actually delivered to the manufacturing facilities of the manufacturer. The intermediary is in a good position to take ownership of the inventory. The intermediary also may be in a good position to secure a guarantee from the manufacturer to purchase the inventory within a pre-agreed time period. The intermediary alternatively may be in a good position to obtain an assignment of accounts receivable from the inventory supplier. In either case, the intermediary can have possession, ownership and/or control of the inventory, and at least one of a guarantee to purchase inventory from the manufacturer or an assignment of accounts receivable from the inventory supplier The intermediary has the unique ability to bundle these assets together and generate a credible basis for financing.

In such a case, the intermediary can obtain a lower cost of financing from the financier than can the supplier. The intermediary can give the inventory supplier a much shorter payment cycle than the manufacturer, while at the same time charge a much lower interest rate than the supplier can where the supplier approaches the financial intermediary individually.

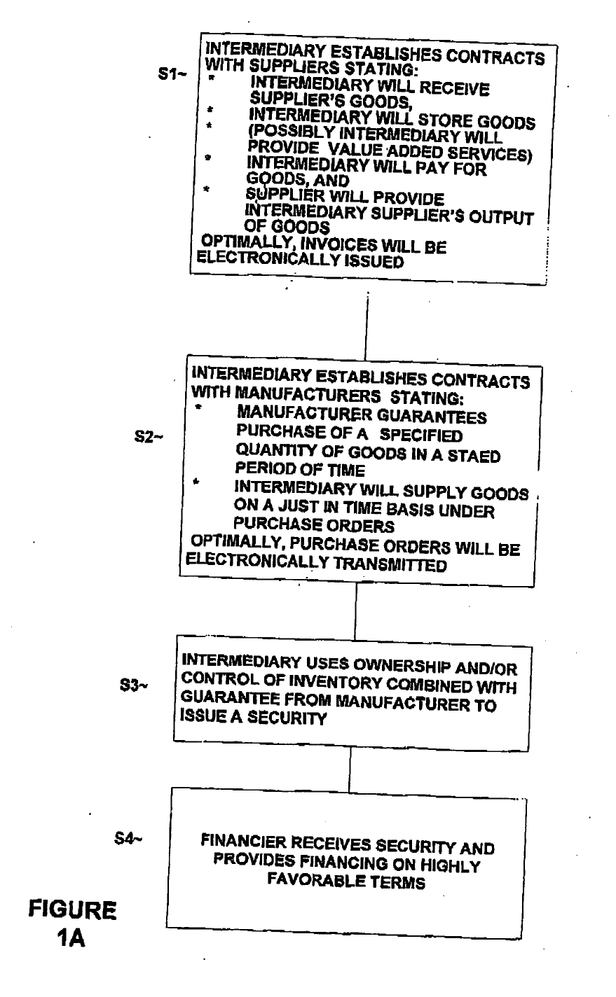

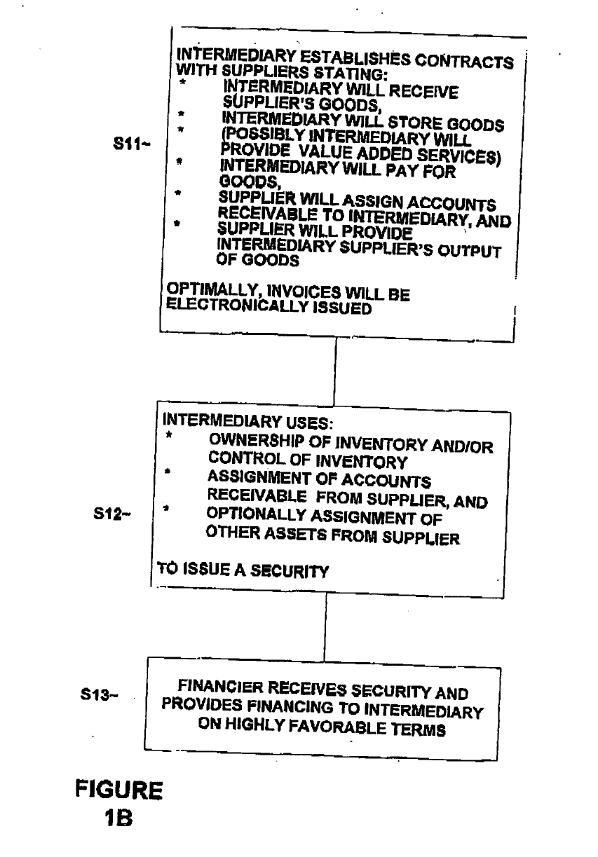

In implementing zero inventory method financing, according to one exemplary embodiment, the intermediary win (1) obtain possession, ownership and/or control of the inventory, and (2) the intermediary will establish contracts with both the manufacturer and the inventory supplier for implementing zero inventory model (ZIM) financing, as illustrated in the flowchart of FIG. 1A.

The intermediary will secure a contract with the inventory supplier as represented by step S1 with the following exemplary terms, although many others may be used:

That the supplier will supply inventory to the supply chain intermediary within 3 days of receiving an intermediary purchase order form, from the intermediary.

That the supplier shall supply the intermediary inventory according to data contained in all intermediary purchase order forms transmitted from the intermediary to the supplier within a 60-day period, at the fixed unit price.

That the supplier will issue an invoice electronically to the intermediary with the following details:
<Supplier Transaction Number><Invoice Number><Transaction Date and Time>&<Purchase Order Code>%%%<Destination Manufacturer ID Number>%%%#<Item Code?Item Quantity?>#%%%<Transaction Termination Number>
That the supplier will be paid according to the following payment terms:
Payment to specified bank account within 7 days from date of receipt of inventory at the intermediary's storage facilities.
Payment to be discounted from original invoice value at the rate of X %.

The intermediary also will enter into a contract with the manufacturer, as represented in step S2, with the following exemplary terms, although many others maybe used:
That the manufacturer unconditionally purchase the entire value of the inventory (at a fixed unit price) from the intermediary, within a time period of 60 days.
That the manufacturer can implement the purchase in multiple purchase orders within the time period of 60 days.
That the purchase orders be electronically transmitted to the intermediary in the following (exemplary) format:
<Manufacturer Transaction Number><Invoice Number><Transaction Date and Time>&<Purchase Order Code>%%%<Manufacturer ID Number>%%%#<Item Code?Item Quantity?>#%%%<Transaction Termination Number>

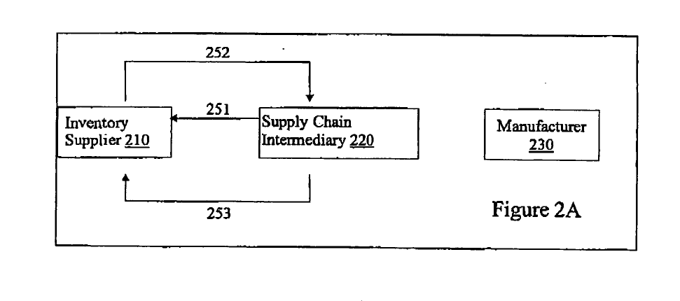

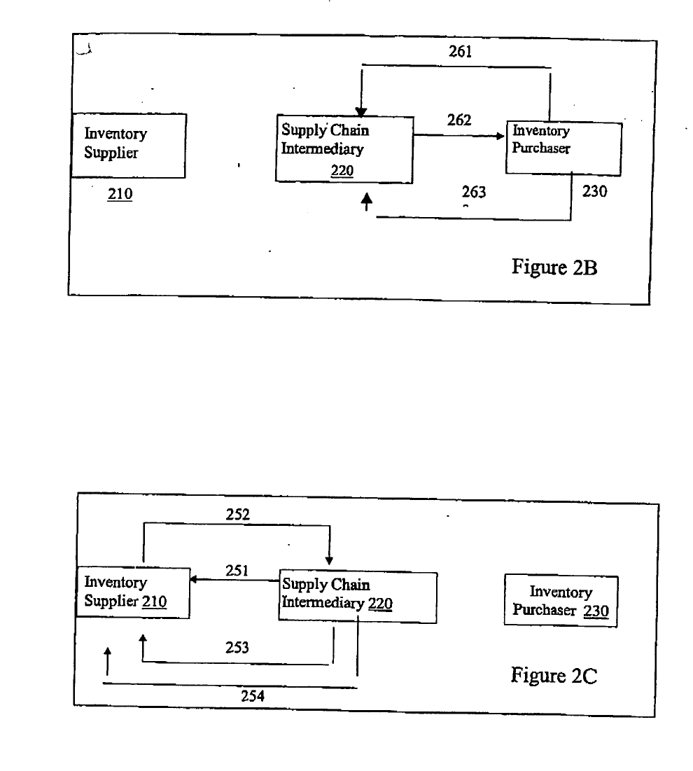

Referring to FIGS. 2A and 2B, an arrangement of a supply chain 200 is schematically illustrated, wherein one or more suppliers 210 (only one is shown but plural suppliers may be involved), who manufacture or assemble components, provide their inventory to a supply chain intermediary 220 for delivery to a manufacturer 230 (only one is shown but plural manufacturers may be served by the supply chain). As would be understood by one skilled in the art, the supply chain structure maybe much more complex than the simple linear form illustrated in the Figures, and one or more manufacturers 230 may require supplies from one or more vendors via one or more supply chains, where the output of the various suppliers will go into inventory and will be held by the intermediary of a respective supply chain.

In the exemplary embodiment according to the flow chart of FIG. 1A and the arrangement as illustrated in FIG. 2A, the supplier 210, who wishes to provide goods to the one or more manufacturers 230, will enter into a contractual arrangement with the supply chain intermediary 220 that requires the supplier 210 to provide goods, and requires the intermediary to accept and store goods, pay the supplier for the goods and provide the goods to a manufacturer (optionally with value added), as in step S1. In the transactions underlying this arrangement, the intermediary 220 will transmit to the supplier 210 an intermediary purchase order form in transaction 251. The supplier in turn will provide goods to the intermediary in transaction 252. Payment from the intermediary to the supplier 250 will be implemented in transaction 253, shortly after the invoice is received by the intermediary from the supplier 240, and that the intermediary 200 has received physical procession of the inventory at the intermediary's storage facilities. Immediately upon receiving physical possession of the inventory, and even indicia of ownership or control, the intermediary is in a position to obtain financing to pay on the suppliers invoices. Such financing can be obtained on highly favorable terms using the relationships outlined in FIGS. 2B and 2C.

Referring to FIG. 2B, and with reference also to step S2 in FIG. 1A, the supply chain intermediary 220 also will enter into a contract with the manufacturer 230. The contract will require the intermediary to provide goods from storage on a just in time basis, in quantities stated in purchase orders issued in transactions 261. Payment for the goods will be made on standard commercial terms in transactions 262. However, the intermediary also will require a purchase guarantee 263 from manufacturer 230.

Alternatively, with reference to FIGS. 1B and 2C, the supply chain intermediary 220 also may obtain from the supplier 210 an assignment of accounts receivable from the supplier in transaction 254, as illustrated in step S11. The assignment may relate to the accounts receivable for all or a part of the particular goods that have been delivered to the intermediary, and/or may relate to other accounts receivable due to sales to a third party. In this case, the relationship to the manufacturer 230 is not directly relevant, yet the intermediary can still satisfy the manufacturer's requirements for just in time delivery.

In yet another variation, an alternative asset of the supplier may be used instead of accounts receivable, and may include an inventory consumption forecast, provisional purchase order, purchase order, or provisional contract for purchase, from either the supplier and/or the intermediary's own clients/buyers of inventory.

Whether operating in accordance with the arrangement of FIGS. 1A and 2A, or 1B and 2B, or even a combination of them, the intermediary has both the physical possession and/or ownership of the inventory as well as a second asset, comprising the manufacturer's guarantee or the assignment of accounts receivable from the supplier. This combination of assets enables the intermediary to issue a security (Step S3 in FIG. 1A and Step S12 in FIG. 18) that can be used as a basis for obtaining financing on highly favorable terms (Step S4 in FIG. 1A and Step S13 in FIG. 1B).

When calculating the amount of financing to be provided to the supplier based on the relevant asset values, some or all of the following steps may be taken: (1) computing the net value of the inventory assigned from the supplier to the intermediary; (2) computing the net value of the accounts receivables assigned from the supplier to the intermediary; (3) deriving a combined value of the two assets assigned from the supplier to the intermediary; and (4) attaching a financing cost chargeable to the supplier based on the combined value.

The intermediary may also include in the financing cost the supplementary costs and expenses relating to its provision of services to the supplier, including, but not limited to: (1) the net cost of information technology; (2) the net cost of warehousing, logistics and transportation; and (3) the net cost of risk, insurance, inventory insurance, and accounts receivables administration. Some or all of such net costs would be added to said financing cost to derive a total cost of service. The cost of service may be expressed as a percentage of the total value of the inventory, and the intermediary may conveniently offer its services as a percentage of the total value of the inventory.

Consequently, the intermediary can make use of assigned assets from the said customer to consolidate into a single financial instrument that is fully negotiable, having a value comprising of the following:
net value of inventory assigned to the instrument,
net value of accounts receivables assigned to the instrument,
net amount payable to the intermediary due to services provided to the supplier, and
an assignment agreement of the intermediary to assign a net amount payable by the supplier to the instrument.

When the zero inventory model (ZIM™) is applied to a one-to-many model, the benefits are amplified even finer, particularly where there are plural manufacturers from different industries, for example, and/or where the supply chain intermediary is dealing with a multitude of suppliers. For example, assuming a case where there are 5 manufacturers and 1000 suppliers, with a uniform division of just 200 suppliers per manufacturer, the benefits may be significant. Further assume that only 10% of the suppliers are interested in zero inventory model financing, but they sell a collective value of inventory worth $100 million, with an average turn-around of 15 days. The suppliers may have a group median of about 7% for the cost of AR financing. The financier may offer funds ($100 million) for 3.25% if:
The collective purchase guarantees presented by the supply chain intermediary has a diversified risk portfolio from 5 different industries;
Purchase guarantees come with collateral of inventory from 5 different industries; and
Collaterized inventory is sold on a just-in-time basis every 15 days.

This can only be possible if the financier implements asset securitization of the collective cache of guarantees and collateral presented. Asset securitization may be obtained in any of a number of ways, including discounting the face value of the secured asset against the seller of the securitization paper, issuing rights to different buyers of the securitization paper at separate rates of discount, etc. The financier must use securitization and cannot provide a bank loan to the supply chain intermediary for 3.25%, since the cost of capital is probably pegged to the bank's deposit rates. The supply chain intermediary charges a flat rate of 4.1% to the suppliers—who can can't get rates that are competitive to the one offered by the intermediary. The supply chain intermediary makes a spread of 0.85% on $100 million worth of zero inventory model financed instruments.

Assuming the group median credit term of the 5 manufacturers is 60 days, a simple calculation will mean that the ZIM™ process may be repeated 6 cycles in one year. $5,100,000 of recurring revenue earned each year. This return is obtained from 10% of 1,000 suppliers spanning 5 manufacturers, with a collective inventory value of $ 100 million.

Clearly, in the case of zero inventory financing, there is a primary party driving the financing flow, typically, the supply chain intermediary. The driving party is (1a) securing a guarantee from another entity, or (1b) securing assignment of accounts receivable from another entity, and (2) tying such a guarantee or assignment to another security (such as inventory as collateral) from a financier. The driving party is then making use of this consolidated instrument to procure finding, particularly providing money at a lower cost to the supplier or intermediary. Notably, using this arrangement, the driving party can provide the finds to a consolidated group of entities, or secure the consolidated instruments from such a group to perform financing.

The securitization of a zero inventory model (ZIM™) instrument with a purchase guarantee and pledging of inventory may have the following structure:
Purchase guarantee from manufacturer ABC; and
Inventory pledged to security.

The above structure does not allow for the pledged inventory to go beyond the control of the inventory owner—which in this case will no longer be the supply chain intermediary. The ownership now resides with the purchaser of the security (e.g., the financier), since the supply chain intermediary will need to sell the security to the financier to obtain cash for payment of inventory to the supplier. However, as the manufacturer makes incremental purchases, the value of the pledged inventory will have a mechanism to incrementally reduce the pledged value, and the corresponding liabilities of parties involved. The purchase guarantee must also reflect the change in liabilities of the manufacturer.

Notably, this arrangement is in compliance with current Financial Accounting Standards Board rules, particularly FAS Rule 125 regarding the transfers and servicing of financial assets and extinguishment of liabilities, since the treatment of liabilities and asset obligations is recognized and derecognized at appropriate times when the control of assets changes significantly, as specified in sections (a)-(c) in paragraph 4 of FASB Rule 125. The operating and accounting impact on the manufacturer in one instance is significant, since the manufacturer has the advantage of making incremental purchases on a just-in-time basis by using its rights under the ZIM™ initiated purchase guarantee with the intermediary. The manufacturer benefits from flexibility in operating cash flows, since inventory can now be purchased on a just-in-time basis—however, the financial impact is just the same, since improved cash flow is countered by the issuance of a purchase guarantee to a third party (the supply chain intermediary). Compliance with the FAS 125 rule, however, will mean the presence of operating liabilities (or accounts payable).

The technology involved with the zero inventory model must consider the needs of the several parties, particularly the financier who is asked to take the risk and advance funds on the basis of the securitization issued by the intermediary. Generally, the financier would require the several technology-based assurances before committing to some kind of arrangement to procure and raise funds under the ZIM™ arrangement. First, the financier would have to be satisfied that an electronic message coming from a particular computer system, especially one not under its control, or regulated by rules of a governing authority, is really what it claims to be. The financier will typically engage an independent third party auditing company to implement such system. Today, the system would need to have at least the normal security features of current computer systems, so that the transaction channel would fully mesh with the financier's own internal systems. Some of the following are implementations, which are currently adopted by financiers:
IBM AS400 transaction system (implemented after 1985);
UNIX transaction system (common for EBM OS/390 mainframes),
RC4 security implementation of data and communications, PKI, biometrics, digital certificates etc.;
Multi-tier access control administration;
Network traffic analysis, port control and access administration; and
Secured and dedicated data and communications, including leased lines, VPN etc.

There are of course many other forms and embodiments where separate and distinct systems are used (such as NT, Linux, UNIX-SCO etc.), although there are seldom wide variations in the above configuration.

The technical integration of newer systems such as the AS400 to older mainframes (still forming the bulk of back-end infrastructure) are dependent on the basis for electronic communications between the interfaces that operate transaction processing etc.

The zero inventory model (ZIM™) for trade financing offers a revolutionary shift in financing for suppliers in almost every industrial segment today, since the supply chain intermediary or service provider covers virtually every industry sector. In an operating environment, a small spread of just 25 basis points of the value of the securitized asset can yield minions of dollars in recurring revenue from a relatively small cache of inventory. ZIM™ has the capability of changing the entire financing service level currently in place with tens of thousands of suppliers that power the manufacturing output of the world's largest companies, brands and services. To this end, in implementing zero inventory model financing, certain important components that should be addressed are:
FAS 125 compliance and operating implementation;
Financial performance of supply chain intermediary due to FAS 125;
Technology and data processing/interface;
Technology auditing and accountability reporting;
Efficient transaction systems to minimize processing costs related to FAS 125; and
Benefits versus Considerations analysis for manufacturer.

Consideration of these components, as would be understood by one skilled in the art, would lead to a supply chain system that is adapted to providing low-cost financing for suppliers using a zero inventory model, while being compliant with applicable FAS guidelines.

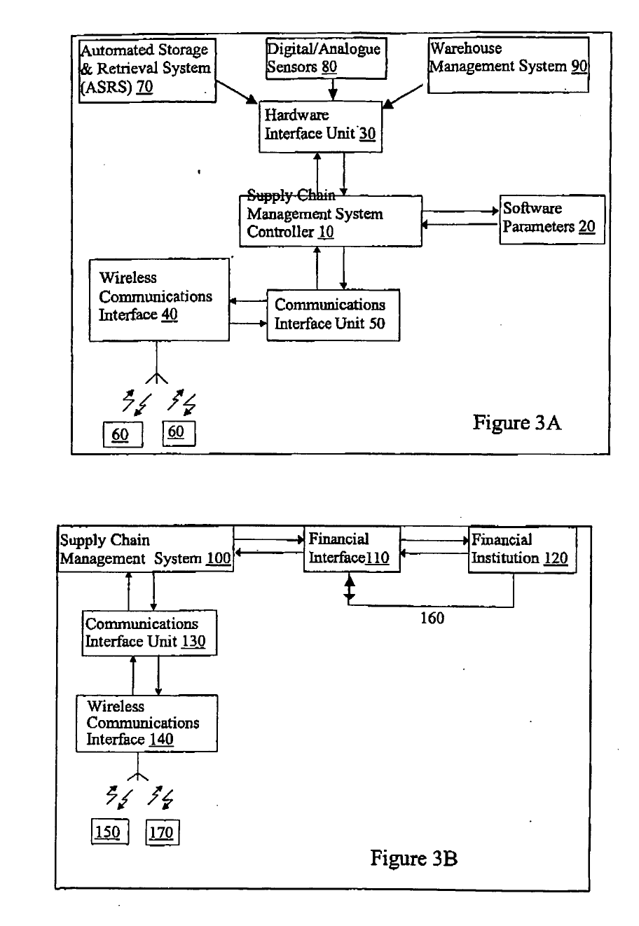

The supply chain system that would implement the zero inventory model would require a reliable and secure event notification system. The system would be adapted to receive electronic data from a multitude of physical manufacturing and storage management computer units and sensors, and would be adapted to securely transmit messages to any device that is connected or registered on the system via public and private systems, including switched networks, wired and wireless systems and the Internet. Referring to FIG. 3A, the core of the supply chain processing and event notification system comprises a computer server 10, which provides a centralized monitoring, data processing, command and control function for the entire system In an alternative embodiment the server 10 may have some or all of its functions distributed, rather than centralized, as is well known in the art. The server 10 is coupled to an analogue-to-digital or digital-to-analogue converter and interface unit 30. The interface unit 30 receives electronic signals and converts them into binary data for information processing by the server 10. Data resulting from the activity of server 10 is stored in a computer database within a memory 20, and may include updated data or new data. The server 10 also retrieves data, in the form of software programing and parameters that are applicable to the signals received from the interface unit 30, from data storage 20. For example, the server 10 may maintain in the database a list of wireless devices 60 that the communications interface unit 50 can electronically alert, and may update that list periodically. The listing may be by unique serial number, address and/or ID, specifically assigned to a respective device 60. The devices 60 may be mobile devices to which the interface unit 50 sends data via a wireless communications unit 40 for electronic alerting of the devices 60.

The storage 20 also stores selections that a registered user of the system pre-programs. For example, the registered user can program the following:
A—Supply chain event or process:
B—Urgency Level 1
C—Urgency Level 2
D—Urgency Level 3:
E—Device name for level 1
F—Device name for level 2
G—Device name for level 3

The storage 20 also can include signal indicator numbers that interface units 30, 40 and 50 may transmit and which correspond to the programmed event or process. The storage 20 also store database tables having reference data fields that match each the urgency level (B), (C) and (D) to each of the device names (E), (F) and (G).

A further desirable system feature, but not necessarily a requirement for the zero inventory model is an electronic proof-of-delivery (ePOD) process. With reference to the sub-system illustrated in FIG. 3B, the process can receive electronic instructions from a mobile device 150, to wireless communications interface twit 140 and communications interface unit 130 to cause the server 100 to initiate an electronic request to another mobile device 170 for user authentication. The authentication is via a user-name and password combination, or a PIN Personal Identification Number or via a combination of an electronic signature. If the authentication is successful, mobile device 170 allows the user to input information, instructions and commands related to acceptance, approval, rejection, and/or confirmation of inventory.

For example, a device 170 may have a capability and display for displaying an electronic menu of options during a delivery of goods from inventory to a intended recipient by delivery personnel. The menu could have one or more of the following menu items and associated implementing software and hardware at unit:
a means to select a delivery order number and/or identification,
a means to allow selected delivery order number to be further coupled with a transaction status, wherein the transaction status includes delivery order completed, delivery order not completed, delivery order delayed, delivery order pending due to exception, delivery order not possible due to recipient not available at location of delivery.

The menu selection can result in a transmission of a message to the controller that establishes an electronic proof of delivery (ePod).

The software and hardware at the supply chain management system controller 10, including the interface components 40 and 50, may comprise a means to accept a range of electronic messages from any number of registered users. On the basis of such messages, the controller 10 may generate electronic commands to direct the flow of inventory from multiple locations to a single central location for one or more of warehousing, assembly and packaging. The messages may also cause the controller to generate electronic commands to direct the flow of inventory either being warehoused, assembled or packaged, from a single central location to multiple, designated locations for delivery. In general such commands will allow for instructions to direct the movement of inventory from one location to another based on the systemic issuance and acceptance of messages from any given number of users having being registered onto the said system. The instructions may include having all information related to inventory being stored onto the system accompanied by data such as assembly/packaging requirements, and having the system to match and generate instructions based on stored parameters about locations that can facilitate the warehousing, assembly and/or packaging of pre-determined inventory type.

The supply chain management system controller 10 also may have software and hardware that comprise a transaction means to allow for other related supply chain processes to be triggered, notified, implemented, and/or alerted to any number of registered users pending the broadcast of individual delivery transaction status and/or confirmation.

The supply chain management system controller 10 will also have software and hardware that enables a user to effect payment 160 of inventory via the user's financial institution 120 to an interface 110 operated by the supply chain intermediary. The payment 160 is effected after mobile device 170 has completed any user input that is required prior to the initiation of payment 160.

The implementation of the functions described herein are readily implemented by those skilled in the art without undue experimentation. Moreover, there are many other modifications that can be made within the spirit and scope of the invention, as would be readily understood by persons skilled in the art. It is to be understood, therefore, that this invention is not limited to the particular embodiments described by way of example herein.

1. A method of financing the provision by at least one supplier of goods to at least one manufacturer via a supply chain intermediary, comprising:
placing a quantity of goods in inventory by said at least one supplier;
taking ownership and control by said supply chain intermediary of said quantity of goods in inventory from at least one supplier; and
securing by said supply chain intermediary a purchase guarantee from at least one manufacturer requiring purchase of said quantity of goods in inventory; and
securing financing by said supply chain intermediary from a financing entity, on the basis of the ownership of said quantity of goods in inventory and said purchase guarantee.

2. The method of claim 1 further comprising,
incrementally purchasing goods by said at least one manufacturer under said purchase guarantee;
delivering incrementally purchased goods by said supply chain intermediary to said at least one manufacturer, on a just in time basis, and
making payment by said manufacturer to said supply chain intermediary as said goods in inventory are delivered on a just in time basis.

3. The method of claim 1 further comprising, paying said at least one supplier for said quantity of goods in inventory by said supply chain intermediary from said financing.

4. The method of claim 1, wherein said agreement of at least one manufacturer is to purchase said quantity of goods in inventory within an agreed time period.

5. The method of claim 4, wherein said agreement of at least one manufacturer is to buy out the entire value of any portion of said inventory remaining unpurchased at the end of said time period.

6. The method of claim 1, wherein said at least one manufacture comprises a plurality of manufacturers, at least two being in different industries.

7. The method of claim 2, wherein said purchase guarantee includes a pledged value of inventory, further comprising,
reducing the pledged value of inventory as the manufacturer takes possession of inventory incrementally based on just in time delivery.

8. A method of claim 1, wherein said step of securing financing further comprises:
implementing asset securitization of said inventory by said supply chain intermediary, on the basis of said purchase guarantee and said ownership of said quantity of goods.

9. A method of claim 1, wherein said step of securing financing further comprises:
creating a negotiable bankable instrument on the basis of said purchase guarantee and said ownership of said quantity of goods.

10. The method of claim 1 further comprising,
providing a payment by said at least one supplier for said quantity of goods in inventory by said supply chain intermediary from said financing, said payment being discounted for supply chain services and costs of said financing.

11. A method of financing the provision by at least one supplier of goods to at least one manufacture via a supply chain intermediary, comprising:
placing a quantity of goods in inventory by said at least one supplier;
taking ownership and control by said supply chain intermediary of said quantity of goods in inventory from said at least one supplier in exchange for an agreement by said supply chain intermediary to pay for said quantity of goods, creating at least one supplier account receivable;
obtaining by said supply chain intermediary assignment of said at least one supplier account receivable; and
securing financing by said supply chain intermediary from a financing entity, on the basis of the ownership of said quantity of goods in inventory and said assignment of said at least one supplier account receivable.

12. The method of claim 11, further comprising:
obtaining by said supply chain intermediary assignment of additional assets from said at least one supplier; and
said securing financing step is further based on said assignment of additional assets.

13. The method of claim 11 further comprising, providing a payment to said at least one supplier for said quantity of goods in inventory by said supply chain intermediary from said financing, said payment being discounted for supply chain services and costs of said financing.

14. A method of claim 11, wherein said step of securing financing further comprises:
implementing asset securitization of said inventory by said supply chain intermediary, on the basis of at least said assigned accounts receivable and said ownership of said quantity of goods.

15. A method of claim 11, wherein said step of securing financing further comprises:
creating a negotiable bankable instrument on the basis of said purchase guarantee and said ownership of said quantity of goods.

16. The method of claim 11 further comprising,
incrementally purchasing goods by said at least one manufacturer from said supply chain intermediary;
delivering incrementally purchased goods by said supply chain intermediary to said at least one manufacturer, on a just in time basis, and
making payment by said manufacturer to said supply chain intermediary as said goods in inventory are delivered on a just in time basis.

17. A method of financing the provision by a supplier of goods to at least one manufacturer, comprising:
the supplier placing a quantity of goods in inventory;
a financing entity taking ownership and/or control of said quantity of goods in inventory from said supplier;
a financing entity obtaining assignment of at least a part of said supplier's account receivables; and
creating a negotiable instrument by said financing entity on the basis of its ownership and/or control of said quantity of goods in inventory and said assignment of said at least a part of said supplier's account receivable.

18. The method of claim 17, further comprising:
obtaining by said financing entity an assignment of additional assets from said at least one supplier; and
said securing financing step is further based on said assignment of additional assets.

19. The method of claim 17 further comprising, providing a payment to said supplier for said quantity of goods in inventory from said financing, wherein said payment is discounted for costs of said financing.

20. The method of claim 19, wherein said payment is further discounted for supply chain services.

21. A method of securitization, involving:
a supply chain intermediary taking ownership of inventory from at least one inventory supplier and securing at least one of a purchase guarantee from an inventory purchaser and an assignment of accounts receivable from said inventory supplier; and
issuing a financial instrument on the basis of a combination of said ownership and at least one of said purchase guarantee and said assignment of accounts receivable.

22. The method as claimed in claim 21, including:
said supply chain intermediary obtaining financing on the basis of said financial instrument; and
said supply chain intermediary making payment to said inventory supplier for said inventory from said financing.

23. The method as claimed in claim 22, including:
permitting said manufacturer to purchase said inventory from said supply chain intermediary on a just-in-time basis;
obtaining payment from said inventory purchase with each said purchase; and
paying down said financing on the basis of said payment.

24. The method as claimed in claim 22, wherein the step of making payment is in an amount based on at least: (1) computing the net value of the inventory assigned from the supplier to the intermediary, (2) computing the net value of the accounts receivables assigned from the supplier to the intermediary; (3) deriving a combined value of the two assets assigned from the supplier to the intermediary; and (4) attaching a financing cost chargeable to the supplier based on the combined value.

25. The method as claimed in claim 24, wherein the financing costs comprise at least one of: (1) the net cost of information technology, (2) the net cost of warehousing, logistics and transportation; and (3) the net cost of risk, insurance, inventory insurance, and accounts receivables administration.

26. The method as claimed in claim 21, wherein said single financial instrument is fully negotiable, having a value comprising:
net value of inventory assigned to the instrument,
net value of accounts receivables assigned to the instrument,
net amount payable to the intermediary due to services provided to the supplier.

27. A supply chain system adapted to support a zero inventory model of financing, comprising:
a supply chain management system controller,
data access and storage means coupled to said controller,
communications means coupled to said controller and being operative to send addressable and broadcast messages, and to receive messages, and
a plurality of remote communication units coupled to said controller via said communications means for receipt of at least one of addressable and broadcast messages and for transmission of messages to said controller, said communication units including at least financial institution units and inventory units, said inventory units being at least one of disposed or disposable at an intermediary warehouse site, transportation site or customer site.

28. A system as claimed in claim 27, wherein said system is provided with conditions and/or details of each supply chain process, said conditions providing an ability to establish and identify the degree of urgency of a condition, and
wherein said supply chain management system controller is adapted to send a message to a specific remote communications unit or plural remote communication units related to said condition and said degree of urgency.

29. A system as claimed in claim 27, wherein said system is adapted to permit registration of said remote communications units at said controller using unique identification data; and
said remote communications units are adapted to send messages related to an electronic proof of delivery to any number of additional registered remote communication units.

30. A system as claimed in claim 27, for implementing an electronic proof of delivery process with regard to an order for delivery of inventory, wherein:
said controller is adapted to transmit a request for confirmation of a transaction status regarding delivery of inventory;
said remote communications units are adapted to receive such request and to transmit a reply regarding acceptance and receipt of inventory; and
said controller is adapted to notify plural remote communications units of the transaction status of said delivery following receiving said reply.

31. A system as claimed in claim 30, wherein said controller is operative to have remote communications units concerned with other related supply chain processes, notified pending the broadcast of individual delivery transaction status and/or confirmation.

32. A system as claimed in claim 30, wherein each said remote communications unit comprises a processor and a display that is operative to display selectable items, said items comprising:
means to select a delivery order identifier, and
means to allow said selected delivery order identifier to be further coupled with transaction status information, wherein the transaction status information includes at least one of delivery order completed, delivery order not completed, delivery order delayed, delivery order pending due to exception, delivery order not possible due to recipient not available at location of delivery, and
wherein said selected order identifier and transaction status information is transmitted to the controller and may serve as an electronic proof of delivery.

33. A system as claimed in claim 27, wherein, said controller further comprises:
means to accept a range of electronic broadcast messages from plural registered remote communications units; and
means for generating in response to selected ones of said messages, electronic commands to direct the flow of inventory from multiple locations to a single central location for at least one of warehousing, assembly or packaging.

34. A system as claimed in claim 27, wherein said controller further comprises:
means to accept a range of electronic broadcast messages from plural registered remote communications units; and
means for generating in response to selected ones of said messages, electronic commands to direct the flow of inventory, comprising at least one of warehoused, assembled or packaged goods, from a single central location to multiple, designated locations for delivery.

35. A system as claimed in claim 27, wherein, said controller further comprises:
means for directing the movement of inventory from one location to another based on the systemic issuance and acceptance of broadcast messages from any of plural remote communication units.

36. A system as claimed in claim 27, wherein, said controller further comprises:
means to generate instructions to direct the movement of inventory from one location to another for purposes of at least one of warehousing, assembly and packaging said inventory, and
means to match and generate said instructions based on stored parameters about locations that can facilitate the at least one of warehousing, assembly and packaging of predetermined inventory types.

37. A method of implementing an electronic proof of delivery process with regard to an order for delivery of inventory in a supply chain involving at least an intermediary and one of an inventory supplier and an inventory purchaser, comprising at least one of:
(1) directing the movement of inventory from an inventory supplier location to an intermediary location, whereby said inventory is moved for at least one of warehousing, assembly and packaging requirements;
(2) directing the movement of inventory from an intermediary location where said inventory is at least one of warehoused, assembled or packaged, to at least one designated intermediary purchaser location; and
(3) transmitting information regarding movement of inventory from a delivery location to at least one other location.

38. The method of claim 37, wherein said transmitting step further comprises:
electronically transmitting a request for confirmation of a transaction status regarding delivery of inventory;
electronically transmitting a reply regarding acceptance and receipt of inventory; and
electronically transmitting to plural locations the transaction status of said delivery following receiving said reply.

39. The method of claim 38, wherein at least one of said steps of directing are based on the systemic transmitting and acceptance of broadcast messages from any of plural remote communication units in order to facilitate the at least one of warehousing, assembly and packaging of inventory.

40. The method of claim 37, further comprising directing payment for inventory in response to said step of transmitting.
